(19) United States
(12) Patent Application Publication
(10) Pub. No.: US 2004/0223225 A1
(43) Pub. Date: Nov. 11, 2004

(54) Arrangement and device for optical beam homogenization

(76) Inventor: Alexei Mikhailov, Dortmund (DE)

Correspondence Address: HOFFMAN WASSON & GITLER, P.C, CRYSTAL CENTER 2, SUITE 522, 2461 SOUTH CLARK STREET, ARLINGTON, VA, 22202-3843, US

(21) Appl. No.: 10/275,157

(22) PCT Filed: Jun. 3, 2002
(86) PCT No.: PCT/EP02/06042

(30) Foreign Application Priority Data
Aug. 17, 2001 (DE) 101 39 355.5

(51) Int. Cl. G02B 27/10

(52) U.S. Cl. 359/619

(57) ABSTRACT

Device for optical beam homogenization with two optically functional boundary surfaces which are opposite one another and which can be used as the entry surface and as the exit surface for light beams, the entry surface and the exit surface having at least in sections lens-like structures, the structures formed on the entry surface and the exit surface being made as convex sections and concave sections which are located in alternation next to one another, the transitions between the convex sections and the concave sections being made relatively smooth. Furthermore this invention relates to an arrangement for optical beam homogenization with a device of the aforementioned type.

### BACKGROUND OF THE INVENTION

This invention relates to a device for optical beam homogenization with two optically functional boundary surfaces. The surfaces are opposite one another and can be used as the entry surface and as the exit surface for light beams. The entry surface and the exit surface having at least, in sections, lens-like structures. Furthermore, this invention relates to an arrangement for optical beam homogenization with a device for optical beam homogenization through which a light beam which is to be homogenized can pass. In the beam direction, there is a collecting lens behind the device, this lens focussing the light beam such that it is more homogenous, for examples in the area of the focal plane of the collecting lens, than before entering the device.

A device and an arrangement of the aforementioned type are known from PCT application WO 98/10317. The device described therein, both on its entry surface and also on its exit surface, has a series of cylinder lenses which are located next to one another and parallel to one another. The cylinder lenses of the entry surface and the cylinder lenses of the exit surface are located perpendicular to one another with respect to their cylinder axis. Behind the device is a collecting lens which can focus the light passing through the device onto the focal plane. With this arrangement, and this devices homogenization can be achieved by the component beams of the light beam which are incident on different areas of the cylinder lenses being deflected to different solid angle elements. The light beam, after passing through the device for optical beam homogenization, is slightly more divergent than before entry. In the collecting lens, components beams incident on the latter in parallel, are deflected such that in the focal plane they are combined at one point. Thus, in the focal plane, superposition of individual component beams takes place, by the prior refraction on the cylinder lenses uniform scattering into different solid angle ranges having been achieved. For this reason, the cross section of the light beam is relatively homogenous in the focal plane. The disadvantage in the aforementioned device, and the aforementioned arrangement, is that the device is composed of convex cylinder lenses located next to one another. In the connecting area of these cylinder lenses extremely strong curvature of the surface of the entry surface and the exit surface is present. The component beams of the light beam to be homogenized, which are incident in these connecting areas, pass through these connecting areas unhindered so that they cannot be homogenized. Alternatively, they are deflected uncontrolled, in the most varied directions, such that they emerge from the beam and can thus be regarded as losses. Furthermore, there is the danger that in these sharp-edged connecting areas, there is a radius of curvature so small that unwanted high-intensity focus formations occur within the device or shortly behind the device. This can lead to damage at correspondingly high laser intensities. At very high laser intensities, it is disadvantageous that they are convex cylinder lenses which form focal lines of high intensity behind the device, for optical beam homogenization, so that damage to the vicinity can occur in these focal areas.

The art discloses devices of the initially mentioned type which have spherically convex lens elements on the entry surface and/or the exit surface. These spherically convex lens elements are located tightly next to one another. They homogenize the light beam in the same way as the aforementioned cylinder lenses and ultimately have the same disadvantages. In particular, as a result of the fact that spherically convex lens elements are used, the danger of damage to the entire apparatus by high-intensity focal areas is extremely great. Furthermore, the transition areas between the individual spherical lens sections are sharp-edged, so that the aforementioned problems can likewise occur here.

The object of the invention is to devise a device and an arrangement of the initially mentioned type which are made more effective.

### SUMMARY OF THE INVENTION

It is provided that the structures formed on the entry surface and the exit surface are made as convex sections and concave sections which are located in alternation next to one another. The transitions between the convex sections and the concave sections are made smooth. By the arrangement of the convex and concave sections next to one another, the transition between these sections can be made relatively smooth without additional steps or edges. In particular, the curvature of the convex section can pass into the curvature of the concave section. In particular, relatively smooth in the sense of the invention means that the transition area between the convex sections and the concave sections compared to the spatial extension of the convex and concave sections is smooth in one direction, perpendicular to the entry surface, and to the exit surface. It has no step or edge which is comparable, with respect to its extension, to the extension of the sections in the direction perpendicular to the entry surface and the exit surface. Relatively smooth in this sense, should not mean that the transition area between the convex and concave sections will not have any surface roughness. Rather, the transition area between these sections should not have any steps or edges which with respect to their spatial extent are much smaller than the spatial extent of the convex and concave sections of the light passage direction.

This relatively smooth configuration of the transitions between the convex sections and the concave sections ensures that the light passing through this transition area is not scattered uncontrolled out of the device. In this way, effectiveness with respect to light yield is increased. Furthermore, this smooth transition does not cause any sharp curves which could lead to high-intensity focal points or focal lines downstream of the device. Furthermore, no light beams incident on this area can pass unhindered through this transitionless connecting area between the convex and concave sections. Therefore, in principle, each of the component beams, incident on the device, is deflected such that optimum homogenization of the light beam which enters the device can be guaranteed.

According to one preferred embodiment of this invention, it is provided that the convex sections and the concave sections each have a direction which lies in the entry surface and the exit surface and along which, at least in sections, the curvature of the sections is essentially constant, the direction of essentially constant curvature of the entry surface being aligned essentially perpendicular to the direction of essentially constant curvature of the exit surface. This yields a structure which is similar to the structure of crossed cylinder lenses as in the existing art. It is provided that a convex, elongated, lens-like structure is always adjacent to the concave, lens-like, elongated structure. In this way, in contrast to the existing art, a smooth transition can be ensured without steps or edges between the convex and concave sections and lens-like structures.

Here the convex sections and the concave sections can have an elliptical shape in the direction perpendicular to the direction of constant curvature. Alternatively, the convex and concave sections can also have a hyperbolic or parabolic or polynomial shape of higher order or a sinusoidal shape in the direction perpendicular to the direction of constant curvature. These surface configurations of the convex and concave sections prevent focal regions with high intensity from forming behind the device for optical beam homogenization. In contrast to spherical lenses or cylinder lenses, for example, elliptical lenses do not have a sharply defined focal region because they have a curvature which changes essentially continuously perpendicular to the direction of constant curvature.

In contrast to a sinusoidal configuration, the convex and concave sections which are made as elliptical, hyperbolic, parabolic or polynomial shapes of higher order additionally have the advantage that they can be made such that extremely effective homogenization of the beam cross sections can take place. This is explained more clearly in the following figure description with reference to FIG. 4.

It can be advantageously provided that the curvature of the convex sections is made on the average weaker than the curvature of the concave sections. In this way, the light intensity in the focal regions is further reduced behind the convex sections. No focal areas are formed behind the concave sections based on the fact that they act like dispersing lenses.

In one embodiment of this invention, which is especially suitable for light beams with lower intensity, the convex sections and the concave sections, in the direction perpendicular to the direction of constant curvature, have a cross sectional shape so that convex and concave cylinder lenses located next to one another form. In addition, these convex and concave cylinder lenses located next to one another contribute to the increase in efficiency because the transition area between these convex and concave cylinder lens sections is made smooth, so that the aforementioned disadvantages known from the existing art do not occur. Only for extremely intense laser beams could focal lines form behind the convex cylinder lens sections, which lines are intense such that unwanted damage occurs.

It is possible to form a large number of convex sections and concave sections, preferably roughly 100 to 500, especially roughly 300, both on the entry surface and also on the exit surface. Depending on the application, this number of convex and concave sections next to one another can be increased or decreased. This is dependent among others on the quality of the intensity distribution of the cross section of the incident light beam.

Other features and advantages of this invention become clear based on the following description of preferred embodiments with respect to the attached figures.

### BRIEF DESCRIPTION OF THE DRAWINGS

FIG. 1a shows a schematic side view of an arrangement as claimed in the invention for beam homogenization;

FIG. 1b shows a side view turned by 90° relative to FIG. 1a;

FIG. 1c shows diagrams which show the intensity distributions of the beam at individual locations of the beam path shown in FIG. 1a and FIG. 1b;

FIG. 2a shows an overhead view of one section of a device as claimed in the invention for beam homogenization;

FIG. 2b shows a view according to arrow IIb in FIG. 2a;

FIG. 2c shows a view according to arrow IIc in FIG. 2a;

FIG. 3 shows a detailed side view which illustrates the refraction of a large number of component beams on the lens surfaces of the device for beam homogenization; and

FIG. 4 shows a diagram which illustrates the deflection of incident light by the device as claimed in the invention for beam homogenization to different solid angles depending on the incidence site.

### DETAILED DESCRIPTION OF THE PREFERRED EMBODIMENTS

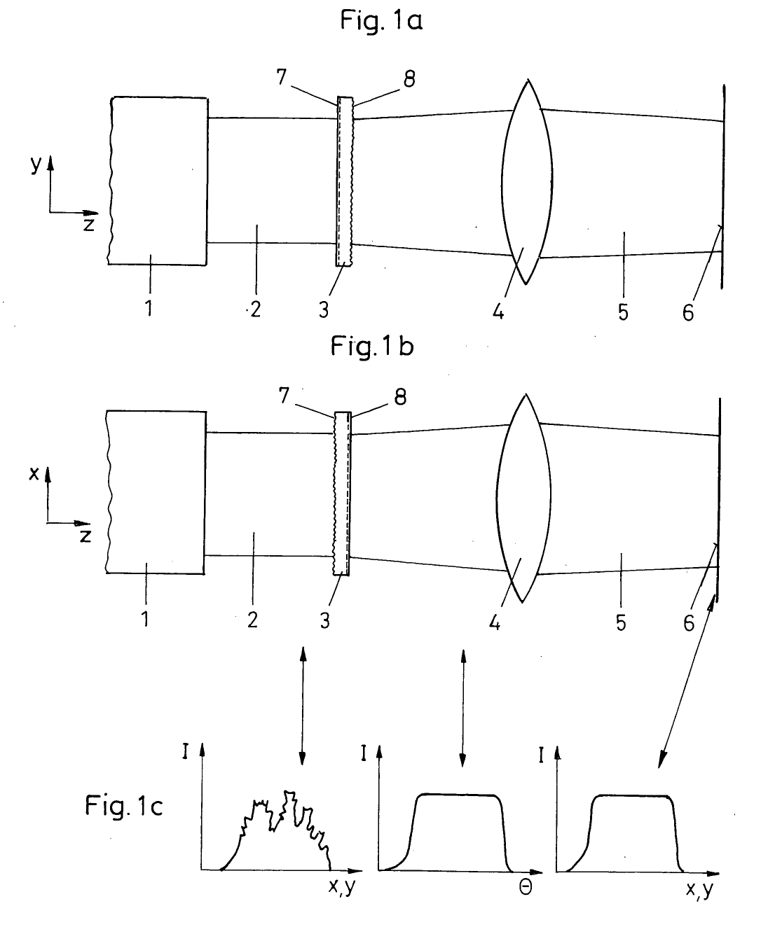

The arrangement shown in FIG. 1a and FIG. 1b includes a light source 1 with a light beam 2 which emerges from this light source and which passes through the device 3 for beam homogenization and is then focussed by a collecting lens 4. The light beam 5 emerging from the collecting lens 4 is shown in FIG. 1a and FIG. 1b in its course as far as the focal plane 6 of the collecting lens 4.

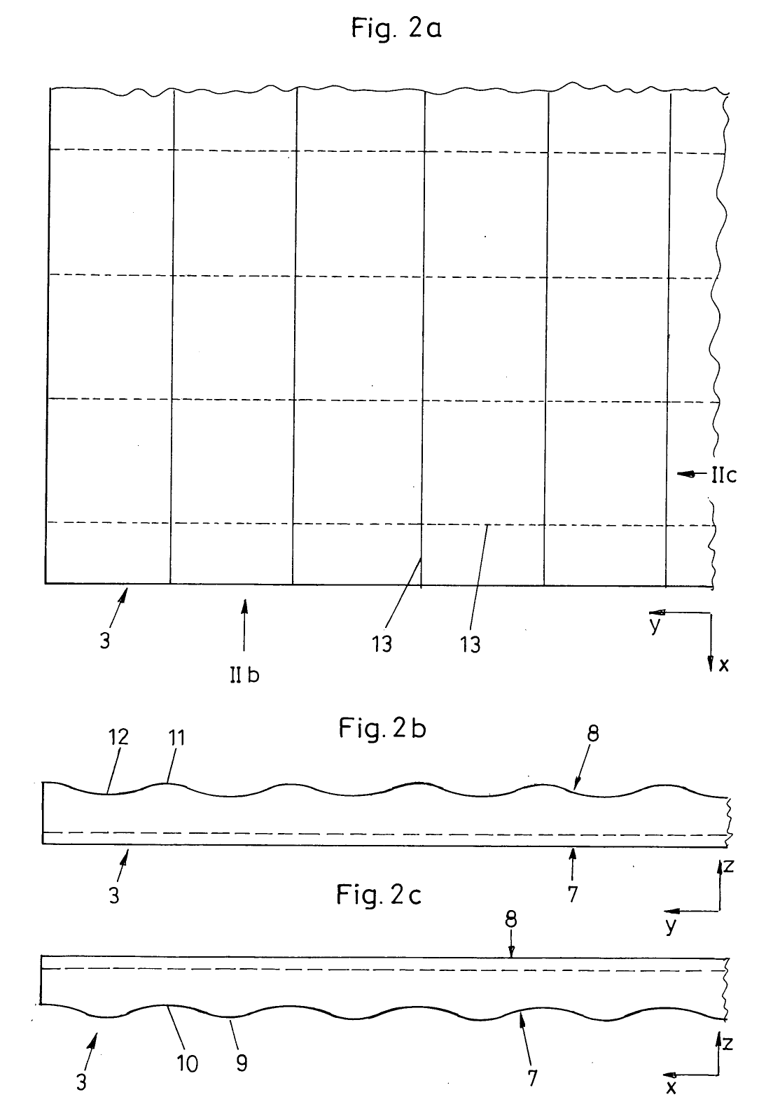

FIG. 2 details the device 3 for beam homogenization. Here the structure of the device 3 is not shown to scale, but exaggerated for clarity. The device 3 has an essentially square entry surface 7 and an essentially square exit surface opposite it. Convex sections 9, 11 and concave sections 10, 12 are formed both in the entry surface 7 and also on the exit surface 8. For example, FIG. 2b shows the convex sections 11 and the concave sections 12 of the exit surface 8 in a profile. Both the convex sections 11 and also the concave sections 12 extend in one direction, specifically in the x-direction with unchanged cross section so that the cross section of the exit surface 8 apparent from FIG. 2b does not change in the x-direction, i.e. into the plane of the drawing in FIG. 2b. The same applies to the entry surface 7 show in FIG. 2c, its cross section not changing in the y-direction, i.e. in FIG. 2c into the plane of the drawing. Both the convex surfaces 9, 11 and also the concave surfaces 10, 12 in cross section have the shape of an ellipse. As a result of this elliptical shape the radius of curvature between the apex lines of the convex sections 9, 11 and the apex lines of the concave sections 10, 12 changes essentially continuously. FIG. 2a shows the apex lines 13 of the convex sections 9, 11 as broken lines and solid lines for illustration.

FIG. 2b shows that the curvature of the convex sections 11 is on the average somewhat weaker than the curvature of the concave sections 12. This applies accordingly to the convex sections 9 and the concave sections 10.

It is important to the invention in this connection that the transition between the convex sections 9, 11 and the concave sections 10, 12 is smooth, especially can be differentiated. This means that the function Z(y) in FIG. 2b and Z(x) in FIG. 2c in the transition areas between the convex sections 9, 11 and the concave sections 10, 12 do not have a step or the like. In particular, for example Z′(y₁)=Z′(Y₂) applies to infinitesimally adjacent points y₁, Y₂ in the transition area between the convex section 9, 11 and the concave sections 10, 12. Here Z′(y) should be the first derivative of function Z(y).

The device which is shown in FIG. 2 can have for example in the x and y direction outside dimensions of 30 mm and in the z direction outside dimensions of 1.5 mm. The convex sections 9, 11 can for example have a width of roughly 30 microns. The concave sections 10, 12 can have a width of 70 microns. The depth, i.e. the extension in the z-direction, of the convex sections 9, 11 from the transition area to the apex point can be less than 1 micron, for example between 0.2 and 0.3 micron. The depth of the concave sections 10, 12 in the z direction can likewise be less than 1 micron, for example 0.8 micron. It is of course also conceivable to choose other dimensions for the device 3. But it is quite sufficient to choose the aforementioned very small depths of less than 1 micron for the convex sections 9, 11 and the concave sections 10, 12. Furthermore, in many applications it is not necessary to choose such a small period wavelength of the sequence of convex and concave sections 9, 10, 11, 12. In this case the period wavelength between the two apex lines 13 of the convex sections 9, 11 is roughly 100 microns. In the corresponding applications it is quite possible to choose period wavelengths between the apex lines 13 in the millimeter range.

For the aforementioned dimensions of roughly 30 mm width and roughly 100 microns period length it is thus possible to place roughly 300 or even more convex sections 9, 11 and concave sections 10, 12 next to one another.

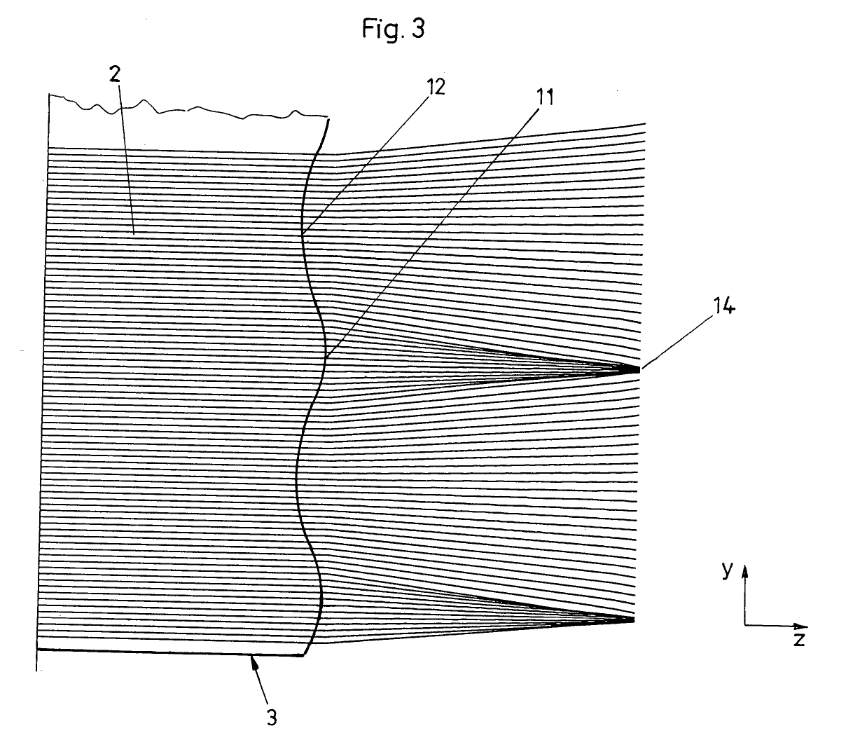

FIG. 3 shows in detail how uniformly the component beams of the light beam 2 which are incident for example on the boundary surface 8 are differently deflected. It is quite apparent that the component beams which pass through the concave sections 12 are scattered away from one another so that in the z-direction behind the concave sections 12 no focussing takes place. The concave sections 12 act here like a dispersing lens. Conversely, component beams passing through the convex sections 11 are caused to approach one another in the focal region 14. The convex sections 11 act here similarly to a collecting lens. This focal region 14 however does not represent a focal point which is very strongly concentrated in space. Rather in the embodiment shown compression of the component beams incident on the convex sections 11 by a factor of roughly 6 occurs. For example, when the convex section 11 in the y direction in FIG. 3 expands by roughly 30 microns the focal region 14 in the x-direction can have expansion of roughly 5 microns. This still comparatively blurred focal region 14 is formed by the convex section, in contrast to spherical geometry, as is present in regular cylinder lenses, not having a constant curvature, but a curvature which changes essentially continuously as a result of the ellipse cross section.

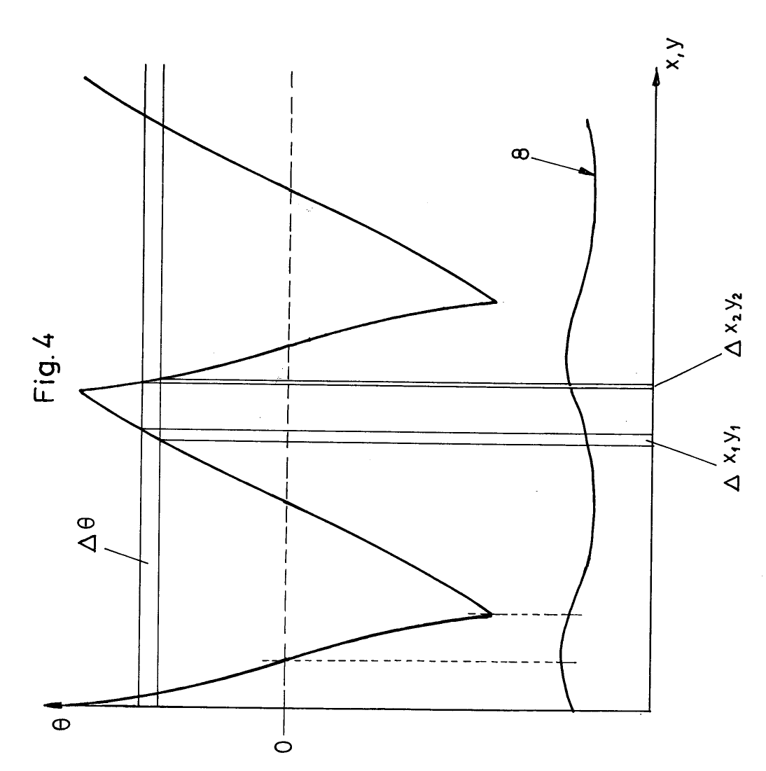

FIG. 4 shows the connection between the component beams incident in certain space regions x, y and the solid angles θ. For better illustration in the lower region of FIG. 4 part of the exit surface 8 is shown schematically. The following considerations apply analogously to the entry surface 7. In particular it is apparent that component beams deflected into the solid angle element Δθ each contain contributions from adjacent space regions Δx₁, y₁, and Δx₂, Y₂. These space regions Δx₁, y₁ and Δx₂, Y₂ are located, as is apparent from FIG. 4, in adjacent concave or convex sections of the exit surface 8. Furthermore, it is apparent from FIG. 4 that intervals Δx₁, y₁ and Δx₂, Y₂ meet function θ(x, y) at different slopes so that the component beams deflected into the same solid angle element Δθ proceed from space regions Δx₁, y₁, and Δx₂, Y₂ of different sizes. This results in that for averaging over the entire exit surface 8 in the y direction and over the entire entry surface 7 in the x direction a very homogeneous distribution of the light intensity into the individual solid angle areas Δθ occurs.

This is shown in FIG. 1c. In the first or left-hand diagram in FIG. 1c the intensity distribution I (x, y) of the light beam 2 before entering the device 3 is shown. FIG. 1c shows that the intensity is distributed very nonuniformly over the cross sectional surface of the light beam 2. One such extremely nonuniform intensity distribution is for example typical for an excimer laser. The middle of the three diagrams in FIG. 1c illustrates that the intensity distribution I (θ) is very homogeneous after passage through the device 3 as claimed in the invention, i.e. essentially the same intensity is also emitted into the same solid angle elements θ. The right-hand diagram in FIG. 1c shows that the collecting lens 4 can result in that in the focal plane 6 of the collecting lens 4 the intensity distribution I (x, y) of the light beam 5 can also be homogenized with respect to the spatial distribution. This is due to the fact that light beams incident in parallel on the collecting lens are focussed in the focal plane 6 at one point so that a homogeneous intensity distribution I (x, y) with respect to the spatial distribution is formed from a homogeneous intensity distribution I (θ) with respect to the solid angle.

Based on the fact that the entry surface 7 and the exit surface 8 are spaced apart from one another in the z-direction, the focal regions 14 of the component beams refracted by the convex sections 9 of the entry surface 7 and the component beams refracted by the convex sections 11 of the exit surface 8 do not overlay one another. Rather they will be spaced apart from one another accordingly in the z-direction. Thus, areas of overly high intensity will not form here. The same is of course also achieved by the surfaces with the ellipse-like cross section being chosen as was illustrated above.

It is also quite possible to replace the ellipse geometry of the cross sections of the convex and concave sections by other shapes. Here for example, hyperbolic, parabolic and surfaces of a higher order of polynomials are possible. Here it is advantageous that surfaces of constant curvature are not selected since in this way unwanted intensity peaks could form behind the device for beam homogenization. Surfaces with a sinusoidal cross section can also be used to a limited degree. But the problem in sine surfaces is that the intensity distributions after passage through one such surface are generally not completely homogenous, but have an intensity reduction roughly in the middle of the beam cross section.

In a deteriorated embodiment of this invention, it is also possible, instead of the elliptical cross sections of the convex and concave sections, to choose surfaces of constant curvature, especially surfaces with spherical cross section. By choosing spherical surfaces thus a convex cylinder lens which acts as a collecting lens and a concave cylinder lens which acts as a dispersing lens are obtained in alternation. The disadvantage here is that behind the convex cylinder lenses relatively narrow focal regions form which at very high intensities of the light beam incident on the device 3 can lead to undesirably high intensities in the focal points which under certain circumstances can cause damage. One such device 3 built with spherical surfaces is thus suited only for applications for light beam intensities which are not very large.

Nevertheless one such device 3 of cylinder lenses crossed to one another on the entry surface 7 and the exit surface 8 can be used as claimed in the invention because the transition areas run smoothly between the convex and concave sections. For example, for the convex and concave sections the same radii of curvature can be chosen. What is important is simply that the transition area between the convex and concave sections can be approximately differentiated so that no steps or other disruptive offsets arise.

1-9. (canceled).

10. A device for optical beam homogenization with two optically functional boundary surfaces which are essentially opposite one another and which can be used as an entry surface and as an exit surface for light beams, the entry surface and the exit surface having at least in sections lens-like structures, wherein the structures formed on the entry surface and the exit surface are made as convex sections and concave sections which are located in alternation next to one another, transitions between the convex sections and the concave sections are relatively smooth, the convex sections and the concave sections each having a direction (x, y) which lies in the entry surface and the exit surface and along which at least in sections the curvature of the sections is essentially constant, the direction (y) of essentially constant curvature of the entry surface being aligned perpendicular to the direction (x) of essentially constant curvature of the exit surface, and the convex sections and the concave sections having an elliptical, a hyperbolic, or a sinusoidal shape in the direction (x, y) perpendicular to the direction (y, x) of constant curvature.

11. The device as claimed in claim 10, wherein the transition area between the convex sections and the concave sections compared to a spatial extension of the convex and concave sections is smooth in one direction (z) perpendicular to the entry surface and to the exit surface, has especially no step or edge which is comparable with respect to its extension with the extension of the sections in the direction (z) perpendicular to the entry surface and the exit surface.

12. The device as claimed in claim 10, wherein the curvature of the convex sections is made on the average weaker than the curvature of the concave sections.

13. The device as claimed in claim 10, wherein a large number of convex sections and concave sections, approximately roughly 100 to 500 sections are formed both on the entry surface and also on the exit surface.

14. An arrangement for optical beam homogenization with a device as claimed in claim 10, for optical beam homogenization through which a light beam which is to be homogenized can pass, in a beam direction there is a collecting lens behind the device, this lens focusing the light beam such that it is more homogenous in the area of the focal plane of the collecting lens than before entering the device.
